(19) United States
(12) Patent Application Publication
(10) Pub. No.: US 2025/0319635 A1
(43) Pub. Date: Oct. 16, 2025

(54) METHODS AND SYSTEMS FOR HIGH THROUGHPUT SEPARATION AND RECOVERY OF PLASTICS FROM WASTE MATERIAL

(71) Applicant: Thomas Valerio, Atlanta, GA (US)

(72) Inventor: Thomas Valerio, Atlanta, GA (US)

(21) Appl. No.: 19/236,858

(22) Filed: Jun. 12, 2025

Related U.S. Application Data
(63) Continuation of application No. PCT/US2023/083684, filed on Dec. 12, 2023.
(60) Provisional application No. 63/431,998, filed on Dec. 12, 2022.

(51) Int. Cl. B29B 17/02; B29B 17/00; B29K 25/00; B29K 55/02; B29L 31/30

(52) U.S. Cl. CPC B29B 17/02; B29B 2017/001; B29B 2017/0203; B29B 2017/0224; B29B 2017/0234; B29B 2017/0237; B29B 2017/0272; B29K 2025/06; B29K 2055/02; B29L 2031/3055

(57) ABSTRACT

Methods and systems presented herein are designed for processing waste material to extract plastics. These methods and systems encompass comminution and various stages of gravity separation. For comminution, a ball mill or a rod mill can be employed. The waste material can be or can include automobile shredder residue.

### STATEMENT OF RELATED PATENT APPLICATIONS

This application is a continuation of International Patent Application No. PCT/US2023/083684, filed on Dec. 12, 2023, which claims the benefit of U.S. Provisional Patent Application No. 63/431,998, filed Dec. 12, 2022, each of which is incorporated by reference herein in its entirety.

### TECHNICAL FIELD

This application relates to systems and methods designed for the extraction of plastics from waste materials, particularly those containing fibrous components, through either wet or dry processes. Furthermore, it also relates to methods and systems for extracting plastics from waste streams. These waste streams typically originate from light fractions which include plastics intertwined or embedded within fibrous materials, a common byproduct of various coarse processing methods.

### BACKGROUND

The recycling of plastics offers several advantages compared to producing new, or virgin, plastic from petroleum. Typically, the process of manufacturing products from recycled plastic, sourced from post-consumer and post-industrial waste as well as plastic scrap (hereafter collectively referred to as “waste plastic material”), requires less energy than creating similar products from virgin plastic. Additionally, recycling plastics eliminates the necessity of disposing of plastic materials or products. It also conserves limited natural resources, such as petroleum and polymers, which are otherwise expended in the production of virgin plastic materials.

Recycling of waste materials is increasingly recognized as essential for both economic and environmental reasons. Recyclables, once properly sorted, can often be sold for substantial profit. Many valuable recyclables do not decompose quickly, making their recycling crucial in alleviating pressure on local landfills and, by extension, the broader environment.

A significant challenge in the segregation of different types of plastics arises from their similar densities. This similarity can lead to the gravity separation stage producing a product stream that, for instance, comprises two primary and four secondary types of plastics. Achieving complete purification through subsequent separation methods, such as electrostatic separation, is often complicated due to the diversity and multitude of plastic types and grades involved.

A significant portion of plastics produced by modern manufacturers ends up in landfills or incinerators, largely due to the lack of economically viable recovery technologies. Durable goods like automobiles, appliances, and electronics contribute to over one-third of the plastics in municipal waste. There is a growing trend to collect and partially recycle these goods at the end of their lifespan to minimize disposal costs, mitigate potential liabilities, and salvage metals and other valuable raw materials.

The composition of automobile shredder residue (ASR) and electronic waste shredder residue (ESR) is highly varied, including rubber, wood, metals, wires, circuit boards, foam, glass, and other non-plastic materials. For effective recycling of plastics, these materials must be segregated into distinct product and byproduct streams. Recycling processes must be adaptable to a range of plastic-rich materials sourced from both post-industrial and post-consumer waste to achieve commercial viability.

Many processes for identifying and separating materials are known in the art. However, not all processes are efficient for recovering plastics and the sequencing of these processes is one factor in developing a cost-effective recovery process. Accordingly, there is always a need for improved methods and systems for recovering plastics from a waste stream.

### SUMMARY

This application discloses methods for processing waste material to separate plastics. The method for recovering plastics from waste material includes: receiving waste material comprising plastic; sizing the waste material by size and shape to recover a sized fraction; comminuting the sized fraction with a ball or rod mill to liberate and separate the plastics, thereby obtaining a mix of plastics and non-plastics; separating material using gravity separation at about 1.0 SG into first lights and first sinks; and separating the first lights using gravity separation at about 1.15 SG into second lights and second sinks. The second lights are Acrylonitrile Butadiene Styrene (ABS) and Polystyrene (PS) plastics, while the second sinks are other polymers, such as filled polymers, which can be further processed.

One aspect includes methods for recovering plastics from waste material that involve receiving waste material containing plastic; sizing the waste material by size and shape to recover a sized fraction; comminuting the sized fraction to liberate and separate the plastics, thereby obtaining a mix of plastics and non-plastics; conducting a first gravity separation within a range of 0.95 to 1.05 SG, resulting in first floats and first sinks; and performing a second gravity separation on the first sinks at 1.1-1.2 SG to obtain second floats and second sinks, with the second floats being primarily ABS and PS plastics.

Another aspect includes a method where comminuting the sized fraction is specifically achieved using a ball mill, enhancing the liberation and separation of plastics.

Another aspect includes a method in which the first gravity separation is performed at 1.0 SG.

Another aspect includes a method in which the second gravity separation is performed at 1.15 SG.

Another aspect includes a method in which comminution is carried out with either a ball mill or a rod mill.

Another aspect includes a method in which the sizing step involves sorting the waste material by shape.

Another aspect includes a method in which the gravity separation process is conducted in two distinct stages, first at 1.0 SG and then at 1.15 SG, for precise and efficient separation of plastic materials.

Another aspect includes a method in which the second floats obtained from the second gravity separation specifically comprise ABS and PS plastics, targeting the recovery of these materials.

Another aspect includes a method that involves optimizing the comminution process by adjusting the operational parameters of the ball or rod mill to maximize the liberation and separation of plastics.

Another aspect includes a method that involves shredding the waste material with a shredder.

Another aspect includes a method in which the waste material includes residue from shredding an automobile.

Another aspect includes a method that involves pelletizing the extracted plastic material.

Another aspect includes a method that involves sorting the second floats by color.

Another aspect includes a system for recovering plastics from waste material, comprising an input assembly configured to receive waste material containing plastic; a sizing unit associated with the input assembly, designed to sort the received waste material by size and shape to obtain a sized fraction; a comminution device in operational connection with the sizing unit, which comminutes the sized fraction, effectively separating plastics from non-plastics to produce a mixture of both; a first gravity separator set within a range of 0.95 to 1.05 Specific Gravity (SG), operatively connected to receive the mixture from the comminution device, conducting the first stage of gravity separation, yielding first floats and first sinks; and a secondary gravity separator, set to a range of 1.1-1.2 Specific Gravity (SG), receiving the sinks from the first gravity separator and dividing them into second floats and sinks. The comminution device can be either a ball mill or a rod mill.

Another aspect includes a system that has a shredder for the initial processing of waste material.

Another aspect includes a system that features a color sorter for additional sorting.

Another aspect includes a system that includes a shaker table to sort the second floats.

Another aspect includes a system that incorporates a ferrous magnet for magnetic separation.

Another aspect includes a system that has a dryer for moisture reduction.

Another aspect includes a system that has a clarifier for liquid waste treatment.

### BRIEF DESCRIPTION OF THE FIGURES

FIG. 1 illustrates an embodiment of a method designed for processing waste material to separate plastics from it;

FIG. 2 illustrates another embodiment of a method designed for processing waste material to separate plastics from it;

FIG. 3 illustrates another embodiment of a method designed for processing waste material to separate plastics from it; and

FIG. 4 shows another embodiment that is a system for separating and recovering plastics from waste material.

### DETAILED DESCRIPTION

This application details various methods and system for purifying plastic from waste materials. In certain instances, the process involves the extraction of unwanted plastics and nonplastic substances from a material consisting predominantly of a single type of plastic. Alternatively, the purification may also entail the removal of undesirable plastics and non-plastic elements from a waste material that comprises a group of two or more types of plastics.

This application encompasses methods and systems for recovering plastics from materials or waste, applicable in both wet and dry processes. Wet processes can include, but are not limited to Streams from preconcentrators, water table concentrators, gold shaking tables (such as those produced by Diester); Wilfery table concentrators; sink float tanks and vessels; snail drums and barrel washers; processes utilizing heavy media, such as DMS separators and hydro-cyclones.

Dry processes may involve roughers like air aspirator Z box aspirator (widely used in the EU for pre-concentrating automobile shredder residue). The light fraction in such residue often contains embedded or entangled plastics along with fibrous materials like carpet, foam, fiber, or fabrics; dry destoners, friction separators, ballistic separators, air tables, cyclones, and blowers; air knife separators or other dry separation devices that differentiate light from heavy materials, where light fractions typically include fuzz and fibrous materials with embedded plastics. Experts in the field are familiar with other relevant wet and dry processes.

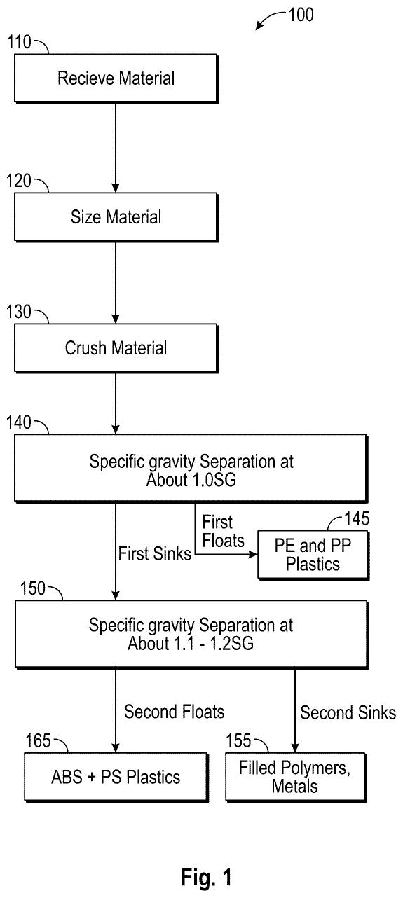

FIG. 1 illustrates an embodiment of a method designed for processing waste material to separate plastics therefrom. This method (100) for recovering plastics from waste material includes: receiving a waste material comprising plastic material (110); sizing the waste material by size and shape to recover a sized fraction (120); comminuting the sized fraction with a ball or rod mill to liberate and separate the plastics from the sized fraction, thereby obtaining a mix of plastics and non-plastics (130); separating material using a first gravity separation at about 1.0 SG into first lights or floats and first heavies or sinks (140); and separating the first sinks using a second gravity separation at about 1.15 SG into second floats and second sinks (150). The second floats (165) are Acrylonitrile Butadiene Styrene (ABS) and Polystyrene (PS) plastics. The second heavies or sinks can include other polymers, such as filled polymers orbrominated polymers (155), and metal that can be further processed.

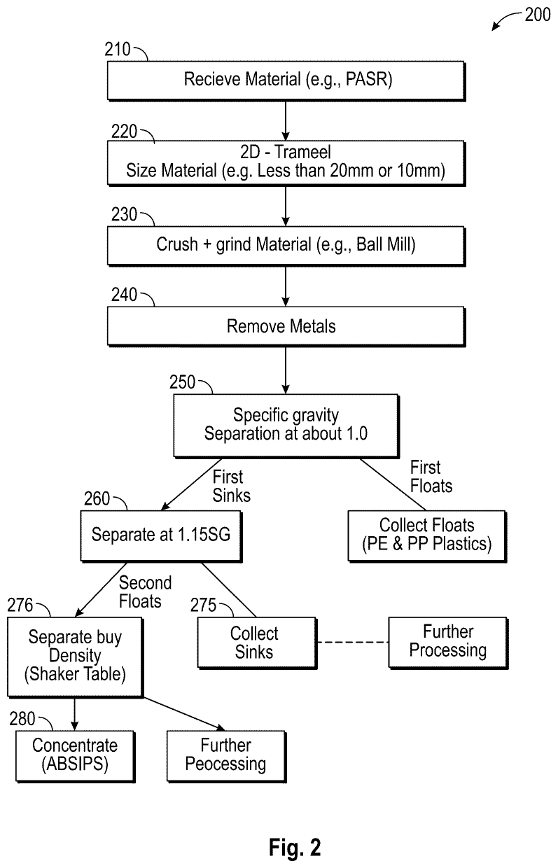

FIG. 2 illustrates an alternative embodiment of a method designed for processing waste material to extract plastics. This method (200) for recovering plastics from waste material involves: receiving waste material comprising plastic, which may include automobile shredder residue (210); sizing the waste material by size and shape to recover a sized fraction (220); comminuting the sized fraction using equipment like a ball mill or rod mill to liberate and separate the plastics from the sized fraction, thus obtaining a mix of plastics and non-plastics (230); removing metals using tools such as a dry magnet (240); and performing gravity separation at about 1.0 SG to divide the material into first lights and first sinks (250). The first sinks are then subjected to a further gravity separation at about 1.15 SG, resulting in second lights and second sinks (260). The second lights (265) primarily consist of Acrylonitrile Butadiene Styrene (ABS) and Polystyrene (PS) plastics. The second sinks (270) include other polymers, such as filled polymers, which can be subjected to additional processing.

As can be seen, density separators are used in the embodiments shown in FIGS. 1 and 2. Density separators in recycling are specialized equipment used to separate materials based on their density. Density separation, often referred to as “float-sink” separation, can include a process used to separate materials based on their density. In density separation, “floats” refer to the materials that rise to the surface of the separation medium due to their lower density relative to that medium. In density separation, “sinks” refer to the materials that settle to the bottom of the separation medium because their density is higher than that of the medium. Density separation exploits the differences in the density of materials to achieve separation. Materials with different densities will behave differently in a medium (liquid or air), allowing for their separation. Example of density separators include, but are not limited to, air separators, hydrocylones, sink-float tanks, jigs (e.g. a 3DS shown in U.S. Patent No. 1,1198,134).

In one embodiment, one density separation is set between 0.9 and 1.1, or 0.95 and 1.05, or at 1.0, or approximately 1 SG, and another is set above 1, between 1.1 and 1.2, between 1.1 and 1.4, or approximately at 1.1 or at 1.1 SG. Given that plastics have a wide range of densities, density separation is a practical and efficient method for sorting them. The material can be separated using gravity separation. In certain embodiments, the lighter material or “lights” has a specific gravity between 1.0 and 1.4, 1.1 and 1.5, 1.2 and 1.4, or 1.3 and 1.4. In this step, the “sinks” undergo further processing, while the “lights” are processed at a specific gravity of 1.0.

In this embodiment, the waste material can screened. Screens are used primarily for sorting and separating different types of materials based on size. They effectively segregate larger pieces of plastic from smaller ones and can also remove non-plastic materials that are mixed in with plastic waste. Examples of screens include trommel screens, vibratory screens and disc screens. These screens may be helpful in removing contaminants and non-plastic materials from the plastic waste stream.

In another embodiment, the waste material can be treated with magnetic separators remove iron. Magnetic separators are used extensively in recycling facilities and scrap yards to recover ferrous metals from various waste streams, including automobile shredder residue, electronic waste, and mixed metal scrap. Magnetic separators utilize the magnetic properties of certain metals to facilitate separation. Ferromagnetic materials like iron and steel are attracted to a magnet, whereas non-ferromagnetic materials are not. Examples of magnetic separators include, but are not limited to, overband magnets, drum magnets, pulley magnets, and the like. The size and type of the magnetic separator, and the speed at which materials pass through the separator all influence the effectiveness of separation.

In another embodiment, the less dense or float material from the gravity separation or processed from the same can be Acrylonitrile Butadiene Styrene (ABS). ABS is a very tough, very durable plastic used in a wide variety of manufacturing. The material is popular for several reasons and has become a standard for many industries and companies. It also helps in homogenizing the material stream, making it more uniform and easier to work with. Examples of size reducer include, but are not limited to, include shredding (cutting), grinding (pulverizing), crushing (pressure), and granulating (chopping). Such equipment can include shredders, hammermills, grinders, and compactors.

In another embodiment, the material can be size reduced. Size reduction in recycling refers to the process of breaking down materials into smaller pieces, typically to facilitate further processing, handling, and recycling. Size reduction makes materials easier to handle and process.

Size reduction typically includes one or more processes at the front end of a plastics recycling plant that are arranged to accomplish a variety of tasks. Size reduction can be implemented to remove metals that can damage size reduction equipment or that can negatively affect downstream separation processes, to reduce the plastic particle size such that much of the non-plastic material is liberated, to create a relatively narrow particle size distribution, and possibly to stabilize the composition of materials sent to downstream processes.

In another embodiment, the material can be treated with color sorter. A color sorter in recycling is a sophisticated machine used to separate items based on their color, an essential function in the recycling of materials like plastics. Color sorters use optical sensors to detect the color of materials as they pass through the machine. In one example, the plastic

Gravity concentration can be used for a number of purposes in addition to segregation of different types of plastics. For example, gravity concentration can be used to separate different grades of the same plastic type.

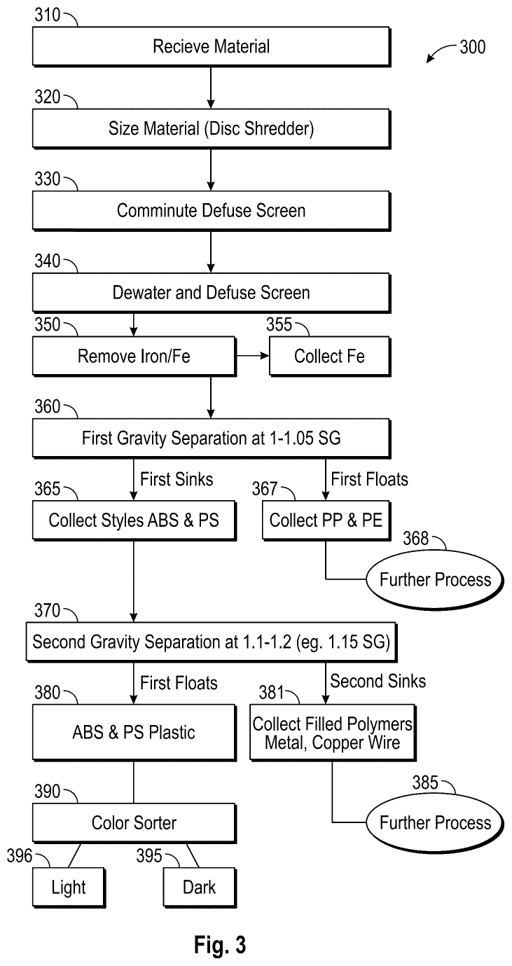

FIG. 3 shows another embodiment of a method designed for processing waste material to separate plastics from it. This method (300) for recovering plastics from waste material includes: receiving waste material comprising plastic, which may include automobile shredder residue (310); sizing the waste material by size and shape to recover a sized fraction, using equipment such as a disc shredder (320); comminuting the sized fraction with a ball or rod mill to liberate and separate the plastics from the sized fraction, thereby obtaining a mix of plastics and non-plastics (330); dewatering and using a defusing screen to remove water (340); removing iron (350) and collecting the same (355) using equipment like a dry magnet or high gauss magnet; separating material using a first gravity separation at about 1.0 SG into first floats and first sinks (360). The first sinks (365) can include materials like ABS, PS, and styrenes, while the first floats (365) can be composed of polypropylene and polyethylene (PE). The first sinks can undergo a second gravity separation at between 1.1 and 1.2 SG (e.g., 1.15 SG), resulting in second floats (380) and second sinks (381). The second sinks (381) can include filled polymers (such as glass filled polymers, talc filled polymers, or other fiber reinforced type polymers), metals, and copper wire among other materials. The second floats (380) can consist of Acrylonitrile Butadiene Styrene (ABS) and Polystyrene (PS) plastics. These second floats can be further sorted into lights (396) and darks (395) using a color sorter. The second sinks can either be further processed using other techniques or disposed of properly.

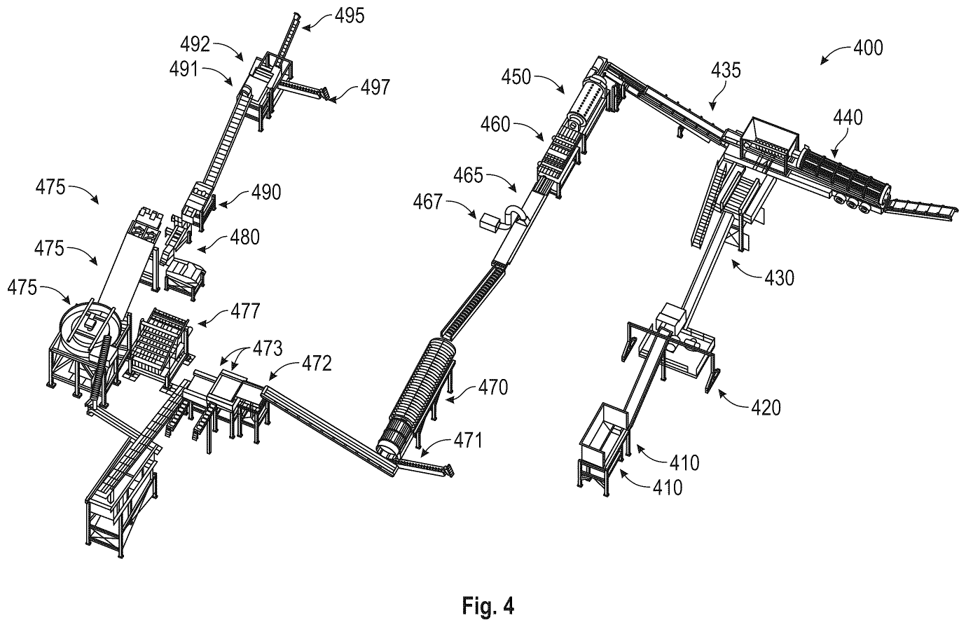

FIG. 4 illustrates an alternative embodiment of a system designated as (400), engineered for the recovery of plastics from waste material. This system encompasses an input assembly (410), tailored to receive potentially shredded waste material via a shredder or disc shredder (420).

It also features a screening unit (430), such as a disc shredder, integrated with the input assembly (410) for sorting the received waste by size and shape to yield a sized fraction. A comminution device (450), either a ball mill or a rod mill, is functionally connected to the sizing unit through a conveyor (435). This device (450) specializes in comminuting the sized fraction, effectively segregating plastics from non-plastics to produce a composite output. A first gravity separator (475), fine-tuned to approximately 1.0 Specific Gravity (SG), is operatively linked to receive the blend from the comminution device (450). Subsequently, a second gravity separator (480) executes an additional stage of gravity separation, resulting in second floats and second sinks. An additional gravity separator, adjusted to a Specific Gravity (SG) between 1.1 and 1.2, processes the sinks from the first gravity separator (475), further partitioning them into second floats, predominantly comprising ABS (Acrylonitrile Butadiene Styrene) and PS (Polystyrene) plastics, and second sinks. Materials emerging from the dewatering screen (490) are then subjected to a shaker table (491) and segregated by color using a color sorter (492) into either dark product (495) or white product (497). An optional component, a slotted trommel (440), can be integrated into the system (400) to accommodate feed waste material containing large hollow objects. Additional elements of the system (400) include a dewatering screen (460), a drying table (465) equipped with a heater (467), a magnet or dry drum (470) with an iron-removal screen (471), high-intensity gauss magnets (473), and a shaker pan (472).

The waste material can be crushed and reduced using a comminution device. In the context of recycling and waste management, particularly for the recovery of plastics from waste material, a comminution device can be used to reduce the size of various materials. The comminution device can also separate the fuzz materials, scrub the surface of plastics, and separate the wood from the material. In the context of recycling and waste management, particularly for the recovery of plastics from waste material. The primary function of a comminution device is to break down materials into smaller pieces or particles. This is achieved through processes like grinding, crushing, or milling. In plastic recovery, the comminution process helps to liberate plastics from other materials in the waste stream, making it easier to separate and recycle them. Common types of comminution devices include ball mills and rod mills, as mentioned in the method for recovering plastics. During operation, the drum of the mill rotates, causing the grinding media and the material to be lifted and then dropped or rolled, creating an impact and grinding action. This action progressively reduces the size of the material. Comminution devices often allow for adjustments in operation parameters like the speed of rotation, the size and type of grinding media, and the duration of the grinding process, to optimize the comminution for different types of materials. The output from a comminution device can be a mixture of reduced-size particles. In plastic recovery, this output will typically be a mixture of plastics and non-plastics, which can then be further processed and separated.

Specific gravity separation is a method used to separate particles based on their specific gravity (SG), which is essentially a ratio of the density of a substance to the density of a reference substance, typically water. Specific gravity separation exploits the differences in specific gravity of particles in a mixture. Since specific gravity is directly related to density, this method effectively separates materials that have different densities. When the mixture is immersed, particles will start to separate based on their densities relative to the medium. Denser particles settle at the bottom, and lighter particles rise to the top. In recycling, it can separate materials like metals and plastics based on their density.

In other words, the initial step involves introducing light materials or concentrates with fibrous content, typically obtained from coarse or preliminary processing. The materials then undergo comminution using a milling device, such as a ball mill, tumbling mill, drum mill, or rod mill. This process effectively separates wood, fibers, or fuzz entangled in or attached to the plastics. Subsequently, the comminuted material is sorted by size. In one approach, this sorting or screening is followed by additional processing to recover materials. Alternatively, the feedstock or crushed material may undergo magnetic treatment (e.g., with magnetite) and is then screened accordingly. An optional step includes sorting for flatter plastics of sizes less than 4 inches, 3 inches, 2 inches, or 1 inch. This size separation can be performed using equipment like a trommel.

The initial waste streams contain amounts of rubber, wood, metal, wires, circuit boards, foam, glass, and other non-plastics. Size reduction methods and systems configured to perform these processes have been developed such that feed streams rich in plastics can be separated into multiple products and byproduct streams. The methods and systems can be applied to a variety of plastics-rich streams derived from post-industrial and post-consumer sources. These streams can include plastics from office automation equipment (printers, computers, copiers, etc.), white goods (refrigerators, washing machines, etc.), consumer electronics (televisions, video cassette recorders, stereos, etc.), automotive shredder residue, packaging waste, household waste, building waste, and industrial molding and extrusion scrap. This material can be processed by specific embodiments of this invention.

This application discloses systems for various sorting of waste material (e.g., automobile shredder residue, municipal waste, or the like). This application includes methods and systems for recovering plastics through the use of comminution (e.g., a ball mill or rod mill). Specific embodiments may be carried out in wet or dry processes on waste material (e.g., automobile shredder residue). That is, a wet process can include a slurry or dry mix of fibrous feedstock (e.g., containing fibrous organic and plastic material and plastics). Specific embodiments include processing of fibrous feedstock that is aspirated lights (light material from an aspirator) and/or lights from a wet rougher or process, e.g., a heavy media plant, or a rising current separation using water.

In one embodiment, the processes and systems were found to be highly effective in recovering plastics from aspirated waste, common in the European Union from processes that do not involve incineration. Aspirators, well known in the classifying art, result in a light fraction having organic material with limited amounts of metal, which tends to be buried/embedded/entangled with the organic fibers. Often, the fibrous feedstock has buried, embedded, or entangled plastic therein. This type of waste is referred to here as aspirated fibrous feedstock. One method for recovering plastics from waste includes roughly or coarsely separating the plastics from the waste to leave a light concentrate, comminuting the light concentrate with a mill to liberate and separate the fibrous feedstock to obtain a mix of a metal fraction and residue, and collecting the plastics fraction and the residue.

The comminution step can be after or downstream of the rough or coarse separation step. In one example, the coarse processing does not include processing with a ball mill or rod mill or more than one or more ball mills or rod mills. In many instances, the waste material is a type where plastics cannot be economically separated from the material, and the material is usually discarded.

After the comminution step or ball mill step, the material may be screened or cut (e.g., between 2-16 mm or 4-12 mm or 6-10 mm or 10 mm). The lighter materials are substantially plastics. The larger materials may be treated by fluidized separation, or an inertia table, and the material less than the cut may be treated using other techniques (e.g., hydrocyclones or spiral separators).

Following the comminution or ball milling step, the material can be screened or sized to specific ranges, such as between 2-16 mm, 4-12 mm, 6-10 mm, or to a uniform size of 10 mm. The lighter fraction of this material predominantly consists of plastics. The larger fractions may undergo fluidized separation or treatment on an inertia table, while the material smaller than the specified cut size can be processed using alternative methods, such as hydrocyclones or spiral separators.

Another embodiment can include a device to remove fuzz. Such devices are known in the art.

In other embodiments, the separation may include an inertia table that includes a frame, a tray or tilt tray, a cam, and a motor. The tray can be secured to (e.g., pneumatic) cylinders/springs/spring-type elements, which can be secured to the frame. Materials processed by the upstream delivery station are accumulated on or conveyed by a tray, which separates and moves material by creating a moment of inertia and/or rotary motion translated into reciprocating/oscillating motion (e.g., a stroke/follower motion). As a result, heavier materials are carried forward and the lighter materials are carried backward. One exemplary inertia table is now available from TAV Holdings, Inc.

Another embodiment includes a method of recovering a plastic product with a given particle size distribution. This method includes loading material with fibrous organic material into a ball mill and operating the ball mill to mill the material to separate or liberate the organic fibrous material from the plastics. The ball milling was able to liberate, separate or remove the fibrous material and was found to result in recovered plastics.

In one example, the ball mill was operated as a wet ball mill. In some examples, the mill or ball mill can be a rod mill, a ball mill, and other equivalents that will occur to those of skill in the art. The mill may be rubber-lined, which gave unexpectedly good results or resulted in substantial separation of the plastics from the fibers. In at least some such examples, crushed material is moved by a conveyor and discharged into a unit where the materials are reduced in size or further processed. In some examples, the mill was operated at less than full capacity or less than half capacity.

In one embodiment, the ball mill application can be downstream from the shredding process, which operations may vary from site to site, but the basic process involves air classification of the “lights” fraction followed by one or more stages of magnetic separation to recover the ferrous metals. Trommels can be used to remove smaller particles, followed by one or more stages of eddy current separations to recover the nonferrous metals.

Conveyors are used to move materials around. In one example, the rejects from the eddy currents can be combined with the “lights” fraction and conveyed to a ball mill. Aggregates and glass are pulverized into smaller fractions than aluminum, copper, and other metals and can be effectively screened.

The waste material may have less than 50%, 40%, 30%, 20%, 10%, 6%, 5%, 4%, 3%, 2%, or 1% of plastics by weight or volume. In some examples, the fibrous light material contains greater than 95% plastics or organics.

Since the amount of recyclable materials recovered may be increased, a monetary amount may be associated with the increase based on the systems or methods as discussed herein in the various embodiments. As a non-limiting example, between about $40.00 USD and about $60.00 USD per ton of shredded material may be additionally recovered based on the amount of salable additionally recovered recyclable materials as compared to past techniques. These values may vary with the market and with the amount of recyclables recovered; however, it may provide a substantial increase in salable materials.

Sorting of traditional waste material may be run once, may be repeated, may be run twice, may be repeated once, may be repeated twice, or more or the like as may be needed.

With regards to the waste stream, specific embodiments can be used to process waste materials or recyclable material that contains a concentration of plastics larger than 15%, or 25%, 35%, 45%, and/or 50%. This means that as long as there is a good concentration of plastics (as low as 20% or larger) the system can properly sort the materials. Household waste that has been presorted into “plastic and non-plastic” streams will be a good example. Typically, household waste that is not landfilled can be presorted at a recycling facility where plastics separation will be generated. This plastics concentrate is one example of a “good feed material.” Municipal waste containing plastics is an exemplary waste stream material.

The plastics recycling process may employ various separation techniques, strategically sequenced to maximize efficiency and yield a valuable mix of products. The arrangement of these processes can vary based on the source, particle size, and characteristics of the waste plastic material. In certain implementations, specific operations may be repeated as necessary to attain the desired purity level or if different stages of the process call for the same operation for distinct purposes.

In one embodiment, the intake material or feed material is pre-processed material. Preprocessing the material can include other steps, which can include gravity separation, density separation, sorting, thickness, friction, and other processing.

The separated plastics may undergo further processing to remove other undesirable material that remains in the plastic streams. For example, a rollback conveyor, which includes an upwardly-inclined conveyor, may be used to remove rounded material, such as foam, from the plastic stream. As the material moves on the conveyor, the round foam and similar material rolls back down the conveyor, as it does not create enough friction to remain on the conveyor as it travels. The material that is removed with this process is typically waste.

Similarly, the material may be transferred to a magnetic belt. Here, any ferrous debris is removed. For example, fuzz or fluff which is carpet fragments from an automobile that has ferrous metal threads, would be removed at this point. This ferrous debris would typically be waste. Other processes may be employed to remove undesirable plastics, such as talc-filled PP, glass-filled, and PVC. These processes may be skipped or additional steps added to arrive at a concentrated plastic stream that can be processed to remove PCBs. The plastic may be further reduced in size as necessary. Alternatively, these pre-processing activities could be done prior to concentrating the plastic materials in a sink/float tank.

Additional separations, tanks, and devices may be added to improve efficiency and speed.

In one embodiment, the feed material can be automobile shredder residue (ASR). Automotive Shredder Residue (ASR), typically constituting 15-25% of a vehicle's mass at its end-of-life stage (post being an End of Life Vehicle or ELV), is the residual material remaining after processes such as de-pollution, dismantling, shredding of the vehicle's body, and the extraction of metals. ASR can be segmented into three categories: ‘light fluff, ‘heavy fluff, and a mineral fraction. Both light and heavy fluff are distinguished by their high concentration of combustible materials, including plastics, rubber, and textiles.

The effectiveness of numerous plastics separation processes can be enhanced by regulating the surface-to-mass ratios of the plastic materials undergoing separation. For instance, in electrostatic sorting, particle deflection is determined by the charge-to-mass ratio, which is generally considered proportional to the surface-to-mass ratio. Additionally, methods like froth flotation and density differential alteration are also reliant on the surface-to-mass ratio of plastics.

A number of methods can be used to control the surface to mass distribution. Sorting by thickness using equipment such as slot sorters or roll sorters can create streams with more narrowly defined surface to mass distributions. Other techniques such as air tables and air classifiers, which depend in part on the surface drag of particles in air, can also be used to separate mixtures into streams with more narrow surface to mass distributions. Large particles with a small surface to mass ratio can be granulated such that they achieve a larger surface to mass ratio. Particles with excessively high surface to mass ratios (fines) can be removed by screening, tabling, or by air classifications.

The separated flakes can be extruded on a single or twin screw extruder. A feed system which can accurately add prescribed amounts of colorants, impact modifiers, antioxidants, and other additives is typically included with the extrusion system.

Although specific embodiments of the disclosure have been described above in detail, the description is merely for purposes of illustration. It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of ordinary skill in the art will, upon considering the foregoing description, recognize that many modifications and variations of the invention may be employed. All such variations and modifications of the invention are intended to be covered by the foregoing description.

1. A method for recovering plastics from waste material, the method comprising:
receiving waste material that includes plastic;
sizing the waste material by size and shape to obtain a sized fraction;
comminuting the sized fraction to liberate plastics and form a mixture of plastics and non-plastics;
subjecting the mixture to a first gravity separation at a specific gravity from about 0.95 to about 1.05 to generate first floats and first sinks; and
subjecting the first sinks to a second gravity separation at a specific gravity from about 1.1 to about 1.2 to generate (i) second floats comprising Acrylonitrile Butadiene Styrene (ABS) and Polystyrene (PS) plastics and (ii) second sinks comprising other polymers.

2. The method of claim 1, wherein the comminuting step is performed in a ball mill or a rod mill.

3. The method of claim 1, wherein the sizing step includes disc-screen sorting of the waste material by shape.

4. The method of claim 1, further comprising shredding the waste material prior to the sizing step.

5. The method of claim 1, further comprising removing ferrous metals from the mixture with a magnetic separator before the first gravity separation.

6. The method of claim 1, wherein the first floats comprise polypropylene and polyethylene.

7. The method of claim 1, further comprising pelletizing the second floats.

8. The method of claim 1, further comprising drying the mixture before the first gravity separation.

9. The method of claim 1, wherein comminuting includes adjusting at least one of rotational speed, residence time, or grinding-media size to maximize plastic liberation.

10. The method of claim 1, further comprising sorting the second floats by colour.

11. The method of claim 1, wherein the second sinks are further processed in a heavy-media separator.

12. The method of claim 1, wherein the waste material comprises automobile shredder residue.

13. A system for recovering plastics from waste material, the system comprising:
an input assembly configured to receive waste material that includes plastic;
a sizing unit operatively coupled to the input assembly and configured to sort the waste material by size and shape to produce a sized fraction;
a comminution device operatively coupled to the sizing unit and configured to liberate plastics from the sized fraction to form a mixture of plastics and non-plastics;
a first gravity separator configured to operate at a specific gravity from about 0.95 to about 1.05 and to separate the mixture into first floats and first sinks; and
a second gravity separator configured to operate at a specific gravity from about 1.1 to about 1.2 and to separate the first sinks into second floats comprising ABS and PS plastics and second sinks comprising other polymers.

14. The system of claim 2, wherein the comminution device is a ball mill.

15. The system of claim 2, further comprising a shredder positioned upstream of the sizing unit.

16. The system of claim 2, wherein the first gravity separator is a sink-float tank and the second gravity separator is a hydrocyclone.

17. The system of claim 2, further comprising a ferrous magnet arranged to remove metals upstream of the first gravity separator.

18. The system of claim 2, further comprising a color sorter operatively coupled to receive the second floats and separate them into light and dark product streams.

19. The system of claim 2, further comprising a dryer configured to reduce moisture content of the mixture before entry into the first gravity separator.

20. A method for recovering ABS and PS plastics from automobile shredder residue, the method comprising:
shredding automobile shredder residue;
sizing the shredded residue by size and shape to obtain a sized fraction;
milling the sized fraction in a ball mill to liberate plastics and form a milled mixture;
subjecting the milled mixture to a first gravity separation at about 1.0 specific gravity to generate first floats and first sinks;
subjecting the first sinks to a second gravity separation at about 1.15 specific gravity to generate second floats comprising ABS and PS plastics and second sinks comprising filled polymers; and
sorting the second floats.
